(19) United States
(12) Patent Application Publication
(10) Pub. No.: US 2025/0013896 A1
(43) Pub. Date: Jan. 9, 2025

(54) GENERATION AND SECURING OF REFERENCE DATASETS FOR ARTIFICIAL INTELLIGENCE ALGORITHMS

(71) Applicant: Asher Orion Group LLC, Pittsburgh, PA (US)

(72) Inventor: John Francis Kalafut, Pittsburgh, PA (US)

(21) Appl. No.: 18/765,288

(22) Filed: Jul. 7, 2024

Related U.S. Application Data
(60) Provisional application No. 63/512,614, filed on Jul. 8, 2023.

(51) Int. Cl. G06N 5/046

(52) U.S. Cl. CPC G06N 5/046

(57) ABSTRACT

A method includes providing a computer system which includes a processor system and a memory system in operative connection with the processor system. The memory system has one or more reference datasets which have confirmed truth stored thereon. Access to data of the one or more reference datasets is secured such that, at least one of: (i) the data of the one or more reference datasets cannot be accessed for use in training artificial intelligence algorithms or (ii) the data of the one or more reference datasets is altered to diminish the viability thereof in training artificial intelligence algorithms. The method further includes providing a portal system to access the computer system over a network via a computing device.

### CROSS-REFERENCE TO RELATED APPLICATIONS

This application claims benefit of U.S. Provisional Patent Application Ser. No. 63/512,614, filed Jul. 8, 2023, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

Artificial intelligence and machine learning are quickly expanding frontiers in many technologies. For example, there has been a recent explosion in the number and type of medical device software products using machine learning (ML) and other modern, data science methods seeking market clearance. Quantitation of oncologic imaging studies holds promise for earlier detection of disease, better characterization of a tumor, and as guiding information in treatment planning and selection. Many US Food and Drug Administration (FDA) cleared products and those seeking clearance make use of supervised machine learning that require broadly representative data for algorithm training, internal validation, and external validation. The FDA requires the conduct of standalone testing of radiologic, artificial intelligence (AI) products to characterize their performance.

Developers/manufacturers, end users/clinical purchasers, and regulators of products incorporating ML and AI encounter a number of problems. It is very difficult, if not impossible, to determine the generalizability of oncology AI products on data not seen in training or that are noisy/dirty. Reviewers, for example, cannot adequately compare new AI products to predicate devices.

When using deep learning networks (and, generally, numerically intense optimization methods) there are few analytical or even heuristic tests a developer can apply to ascertain performance boundaries on input data representative of those to be expected in clinical settings. The standard approach to demonstrate robustness to variation in the distribution of input parameters is to ensure that sufficiently representative, independent data are used in the training stage. For example, in the case of AI algorithms used for oncology, testing data cohorts should be constructed with sufficient variety to represent variations of expected imaging tumor phenotypes, patient demographic and genetic composition, imaging acquisition techniques, common artifacts, and noise processes, and with examples of common ‘mimics’-processes or lesions that may have radiographic similarities to cancerous findings.

Manufacturers expend significant time and economic resources in identifying and securing data sets for external validation that capture the variability and nuances of patients, scanners, imaging techniques, and cancer pathophysiology in the product's intended population of patients. Because most publicly available data sets and those provided by data brokers typically deidentify many parameters descriptive of patient's demographic, racial, and comorbid status, it is challenging to ensure representativeness of patient and cancer progression. Most available data sets also exclude imaging studies that are representative of artifacts, noise, and anatomical variation to be expected in a general oncologic patient population. However, it is desirable (for example, by regulators) to assess how well a product will or will not behave when challenging data are presented to its algorithm.

End users and customers of AI products struggle to determine comparative performance of multiple products. For example, in the representative case of clinical AI products, and particularly oncological AI products, it is difficult to determine comparative performance in addressing a similar cancer type. Often, clinical buyers may perform a trial of an AI product at their site using a limited, representative set of data from their practices. Making meaningful comparisons to results provided by the manufacturer-whether from regulatory validation studies or peer-reviewed publications—can be difficult without access to the source data used in the validation. An evaluation of the performance sufficient for the customer would benefit from having the ability to compare the statistical distributions of known data with those of the site's test set. Such information can be important in gauging the suitability of the product for their oncology patients.

Supervised, machine learning algorithms generally, including those used for oncology applications, degrade over time and don't generalize well. There are no reference standards to baseline performance of an updated model to ensure acceptable deviation in performance as part of an ML lifecycle management process. The manufacturer's process and ‘regression’ testing results may be opaque, at best, to both regulators and customers. In general, regression test typically include re-running of functional and non-functional tests to determine if earlier developed and tested software maintains performance. Moreover, such problem with AI and ML models are not limited to the medical field.

### SUMMARY

In one aspect, a method includes providing a computer system which includes a processor system and a memory system in operative connection with the processor system. The memory system has one or more reference datasets which have confirmed truth stored thereon. Access to data of the one or more reference datasets is secured such that, at least one of: (i) the data of the one or more reference datasets cannot be accessed for use in training artificial intelligence algorithms or (ii) the data of the one or more reference datasets is altered to diminish the viability thereof in training artificial intelligence algorithms. The method further includes providing a portal system to access the computer system over a network via a computing device so that a user can access one of the one or more reference datasets to evaluate the performance of an artificial intelligence model in characterizing (for example, via classification, etc.) one of the one or more reference datasets, wherein the artificial intelligence model was independently trained using a dataset other than the one or more reference datasets. The portal system may, for example, be provided via a web browser.

In a number of embodiments, the memory system further has stored thereon an evaluation algorithm which is executable by the processor system to evaluate performance of artificial intelligence models in characterizing the one of the one or more reference datasets. The method may further include executing the evaluation algorithm to evaluate the performance of the artificial intelligence model in characterizing the one of the one or more reference datasets and providing output of evaluation information characterizing the performance of the artificial intelligence model generated by the evaluation algorithm (for example, via the portal system to the computing device).

In a number of embodiments, the artificial intelligence model is stored in the memory system of the computer system and is executable by the processor system. A plurality of such artificial intelligence models may be stored in the memory system. The artificial intelligence model(s) may, for example, be transmitted to the computer system via the portal system in an encrypted, containerized format from a manufacturer thereof and stored on the memory system. A federated learning platform may, for example, be used to transmit the artificial intelligence model(s) to the computer system.

In a number of embodiments, the user is provided access to the one or more reference datasets to execute a plurality of artificial intelligence models to characterize the one of the one or more reference datasets to evaluate the performance of each of the plurality of artificial intelligence models in characterizing the one of the one or more reference datasets. Each of the artificial intelligence models was independently trained using a dataset other than the accessed one of the one or more reference datasets. One of the plurality of artificial intelligence models may, for example, be a predicate artificial intelligence model.

Each of the one or more reference datasets may, for example, be created based upon predetermined rules defining construction and statistical characterization of the data to be populated therein. The method may further include making information available to the user which describes the process of creation of the one or more reference datasets.

In a number of embodiments, each of the one or more reference datasets is an image dataset wherein an oncologic condition associated with each image dataset thereof is confirmed by at least one of pathologic confirmation or radiographic confirmation. The one or more reference datasets may, for example, be divided into tranche types comprising a cancer subtype reference dataset tranche, an imaging acquisition reference dataset tranche, and an imaging robustness reference dataset tranche. The predetermined rules may, for example, be used in creating the reference datasets to enable evaluation the artificial intelligence model in determining at least one of (i) bias across subgroups, (ii) fairness, and (ii) response to data variation.

In other embodiments one or more of (or each of) the reference datasets is a dataset other an image data set. Such datasets may, for example, include lab data, numerical data, text etc. as known in the AI and computer arts.

In another aspect, a non-transitory, computer readable medium includes instruction stored thereon, that when executed on a processor, effect the actions described herein to, for example, evaluate the performance of an artificial intelligence model in characterizing one of the one or more reference datasets.

In another aspect, a system includes a processor system and a memory system in operative connection with the processor system. The memory system has stored thereon one or more reference datasets which have confirmed truth stored thereon. Access to data of the one or more reference datasets is secured such that, at least one of: (i) the data of the one or more reference datasets cannot be accessed for use in training artificial intelligence algorithms or (ii) the data of the one or more reference datasets is altered to diminish the viability thereof in training artificial intelligence algorithms. The system may further include a portal system to access the computer system over a network via a computing device so that a user can access one of the one of the one or more reference datasets to evaluate the performance of an artificial intelligence model in characterizing one of the one or more reference datasets, wherein the artificial intelligence model was independently trained using a dataset other than the one or more reference datasets.

In a number of embodiments, the memory system further has stored thereon an evaluation algorithm which is executable by the processor system to evaluate performance of artificial intelligence models in characterizing the one of the one or more reference datasets and to provide output of evaluation information characterizing the performance of the artificial intelligence model for example, via the portal system to the computing device.

The artificial intelligence model may, for example, be stored in the memory system of the computer system and is executable by the processor system. A plurality of such artificial intelligence models may be stored in the memory system. The artificial intelligence model(s) may, for example, be transmitted to the computer system via the portal system in an encrypted, containerized format from a manufacturer thereof and stored on the memory system. A federated learning platform may, for example, be used to transmit the artificial intelligence model(s) to the computer system.

Each of the one or more reference datasets may be created based upon predetermined rules defining construction and statistical characterization of the data to be populated therein. The predetermined rules may, for example, be used in creating the reference datasets to enable evaluation the artificial intelligence model in determining at least one of (i) bias across subgroups, (ii) fairness, and (ii) response to data variation. As used herein, the term “bias” is used to refer to anything that causes a systematic error in one direction. “Fairness” has context with judging algorithmic outputs considering not only structural characteristics of the data and or the model but also socio-technological considerations.

As described above, at least one of or each of the one or more reference datasets may be an image dataset wherein an oncologic condition associated with each image dataset thereof is confirmed by at least one of pathologic confirmation or radiographic confirmation. The one or more reference datasets may, for example, be divided into tranche types comprising a cancer subtype reference dataset tranche, an imaging acquisition reference dataset tranche, and an imaging robustness reference dataset tranche. The predetermined rules may, for example, be used in creating the reference datasets to enable evaluation the artificial intelligence model in determining at least one of (i) bias across subgroups, (ii) fairness, and (ii) response to data variation.

As also described above, in other embodiments one or more of (or each of) the reference datasets is a dataset other an image data set. Such datasets may, for example, include lab data, numerical data, text etc. as known in the AI and computer arts.

The present devices, systems, and methods along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates a flowchart of the interaction of three software application modules of a representative embodiment of a portion of system hereof.

FIG. 1B illustrates a flow chart of an embodiment of conceptualization of a scenario wherein collective nodes emerge from a single path through the decision tree.

FIG. 1C illustrates a flow chart providing further details of an embodiment of a scenario configuration sub-process of the embodiment of FIG. 1B.

FIG. 1D illustrates a flow chart providing further details of an embodiment of a generate testing cohort sub-process of the embodiment of FIG. 1B

FIG. 1E illustrates a flow chart of an embodiment of an authoring rule set process.

FIG. 2 illustrates a representative embodiment of a software architecture for a Reference Dataset Builder application of a system hereof.

FIG. 3 illustrates representative data of lung and bronchus cancer type prevalence from the SEER database.

FIG. 4A illustrates a representative embodiment of a system hereof.

FIG. 4B illustrates a flow chart of an embodiment of a process for a system manager or analyst using the system for and review of datasets and experiments.

FIG. 4C illustrates a flow chart of an embodiment of a process for the Reference Dataset Builder.

FIG. 4D illustrates a flow chart of an embodiment of a process for a user of the system.

FIG. 5A illustrates a flow chart of an embodiment of a process to generate a unique, non-fungible token for each object or image in a reference dataset.

FIG. 5B illustrates a flow chart of an embodiment of a process to create a reversible, digital watermark (image perturbing) in each reference data set for data that might be made publicly accessible.

FIG. 5C illustrates a flow chart of an embodiment of a process to allow an authorized user to reverse a watermark perturbing a reference dataset object or image.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an”, and “the” include plural references unless the context clearly dictates otherwise. Thus, for example, reference to “a tranche” includes a plurality of such tranches and equivalents thereof known to those skilled in the art, and so forth, and reference to “the tranche” is a reference to one or more such tranches and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

The terms “electronic circuitry”, “circuitry” or “circuit”, as used herein include, but is not limited to, hardware, firmware, software, or combinations of each to perform a function(s) or an action(s). For example, based on a desired feature or need, a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic”, as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor”, as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller”, as used herein includes, but is not limited to, any circuit or device that coordinates and controls the operation of one or more input and/or output devices. A controller may, for example, include a device having one or more processors, microprocessors, or central processing units capable of being programmed to perform functions.

The term “software”, as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

A number of representative embodiments of devices, systems, and methods hereof, are discussed in connection with Machine Learning/artificial intelligence (ML/AI) models for use in the medical field (for example, in oncological imaging). One skilled in the art will appreciate, however, that the devices, systems and methods hereof are applicable to ML/AI models generally, including in fields outside of the medical field and in connection with data not related to image dataset s (for example, lab data, text, etc.).

In the medical field, ML/AI can, for example, be used to improve the detection and characterization of cancers from medical imaging but there are no common, ground-truth reference data to test and/or compare new (or updated) AI algorithms. Similar problems are present in fields other than the medical field in which ML/AI is used. As described above, sourcing representative data with sufficient variability is time consuming, expensive, and often under-represents the variety of image quality experienced in clinical reality. Trusted and known (ground truth) reference data sets from which manufacturers, customers or regulators can refer to when evaluating the performance of ML algorithms would be of significant benefit.

Regulators and reviewers will, for example, benefit from comparing the performance of multiple products, including predicate devices, using a standard reference. A predicate device is a medical device approved to be legally marketed in the US which is used as a point of comparison for other medical devices seeking approval through the FDA's 510 (k) premarket clearance pathway. A predicate device enables a manufacturer to demonstrate that its new device is substantially equivalent to a device already approved to be legally marketed in the U.S. Multiple manufacturers are building and have built data-driven products to detect, characterize, or diagnose the same type of lesions and/or cancer. A known reference data set would allow reviewers to understand the trends and behaviors of different algorithms architected and trained differently but addressing similar or exact indications. In a representative use-case, a reviewer could interrogate a cleared, predicate device using a reference data set hereof and then compare its results against the product in review.

Whereas curated data sets for researchers and developers exist which can be accessed when building and testing ML models, each manufacturer must expend effort to review and scour those resources for datasets applicable for their application. There also may be restrictions on some publicly available data for use in product development activities. Even when existing public data resources are used in product development, it is not evident to reviewers and regulators that those data sets were used in both training the model and in performing testing. To ensure maximum interpretability of testing results, there is a need for a mechanism to ensure that reference data sets for testing are not directly accessible by manufacturers for inclusion in their training regime. Manufacturers require truly external data, which the algorithm has not seen in training, to demonstrate generalizability.

In a number of embodiments hereof, secure, limited, software-based access is provided to one or more reference datasets or portions thereof to allow developers, users and regulators of, for example, imaging-based oncology AI products to test such products using the one or more developed reference datasets. In general, as used herein in connection with oncological imaging, a reference dataset (RD) is a set of data related to images and imaging (sometimes referred to herein as an imaging dataset) from patients whose oncologic condition is confirmed by pathologic and/or radiographic confirmation (‘truth’). As described further below, the reference datasets are developed using established/predetermined rules and processes. Search and curation methodologies hereof provide improved extraction of data such as oncologic data from one or more data libraries in creating the reference datasets hereof.

The reference datasets are curated and securely made available for use in pre-market and post-market evaluations of imaging-based AI imaging products such as oncologic AI products. The devices, systems and methods hereof assist in streamlining and lowering the costs of pre-market validation testing, which is a critical yet complex step in achieving market clearance of the AI product. Likewise, the devices, systems and methods facilitate post-market testing.

The process describing the creation of reference datasets may be publicly documented. Transparency establishes trust by users of the system hereof. The process, findings and reference dataset creation and sourcing may, for example, be publicly communicated on, for example, a project website such as GITHUB® (available from GitHub, Inc. of San Francisco, California; an internet hosting service for software development) or another publicly accessible platform.

As described above, regulating agency reviewers (or other reviewer) may use the reference data to quantify performance of a newly submitted model against a preexisting or predicate model/device, which is not currently possible. FDA reviewers will benefit from a common, trusted reference data set by allowing for comparison of performance across applicants' devices and predicate devices and by reducing feedback loops to the manufacturers to include testing data that is representative of the intended use. Manufacturers developing oncologic, imaging-based AI products can use the reference datasets hereof in their pre-market validation activities to reduce their expense and time when performing standalone performance assessments.

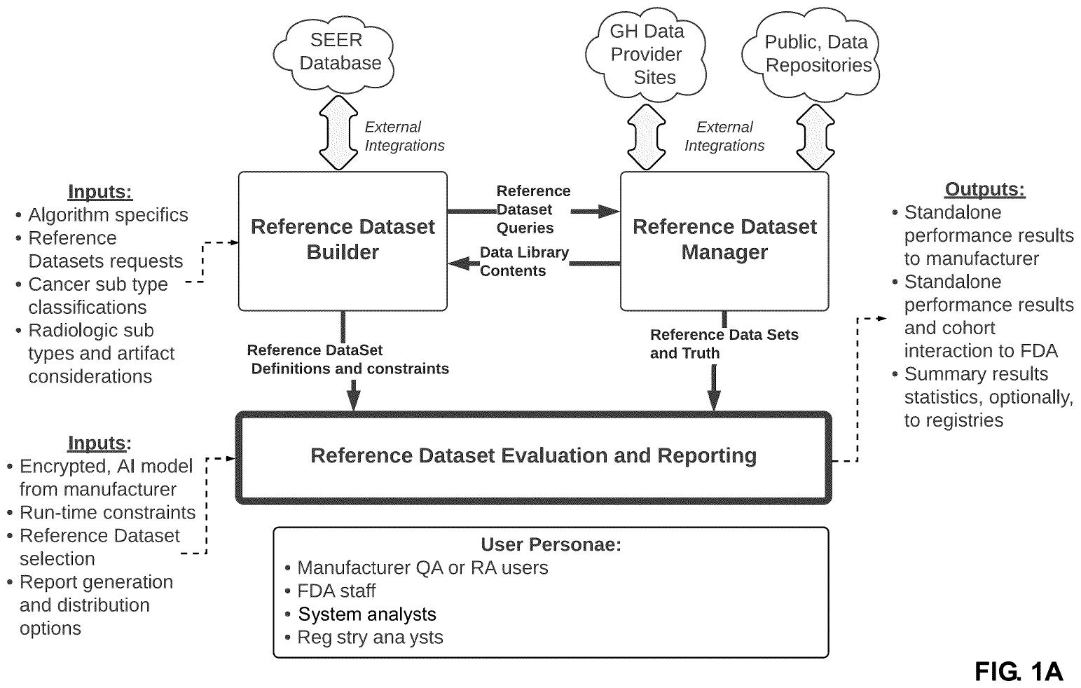

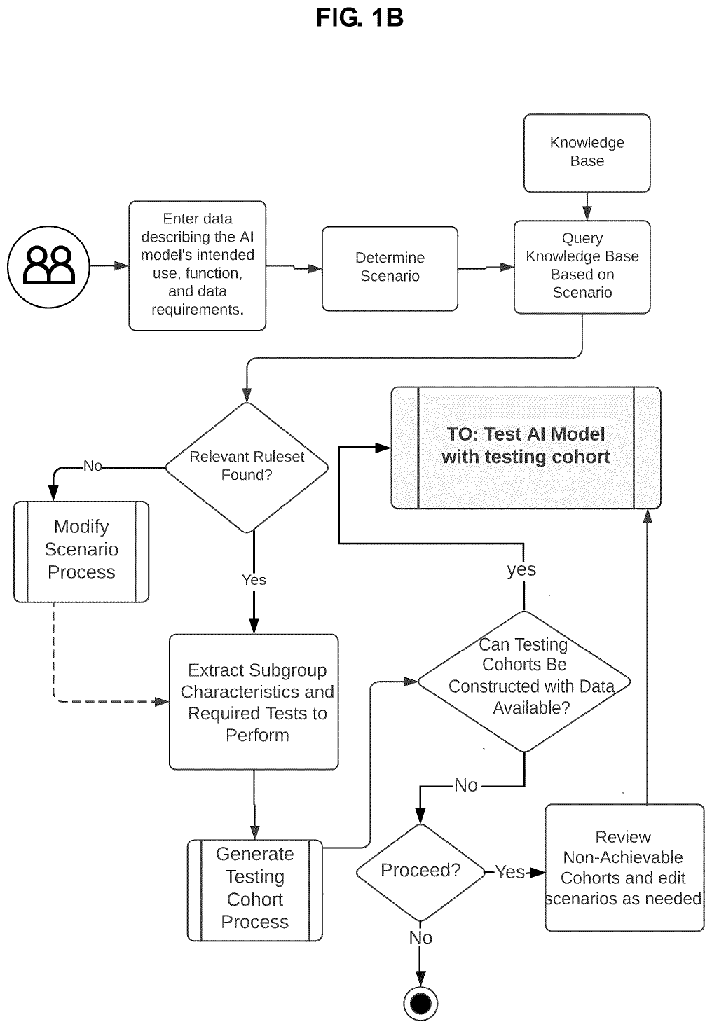

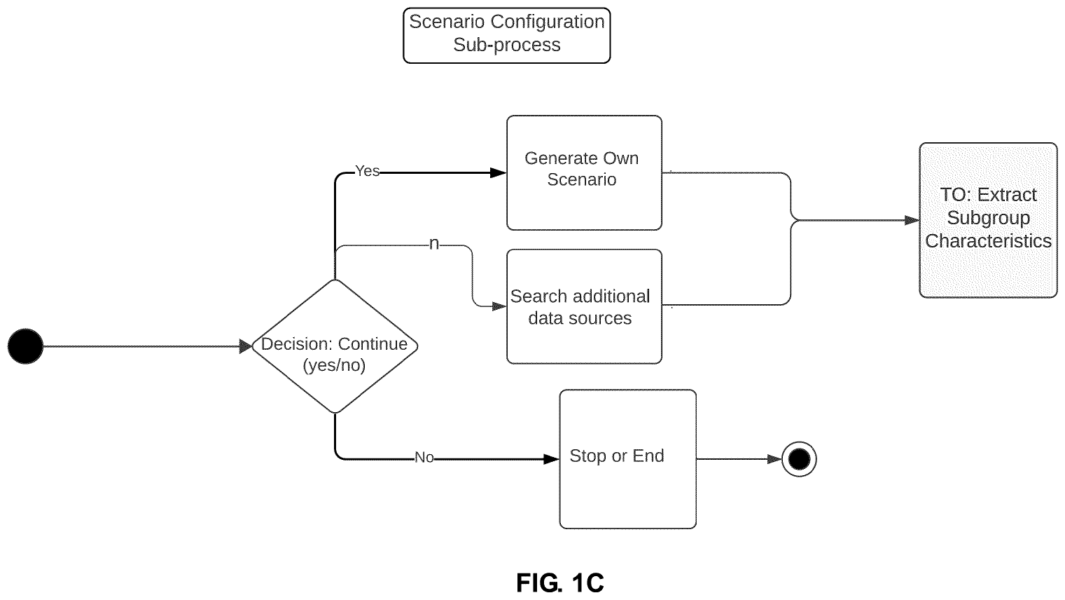

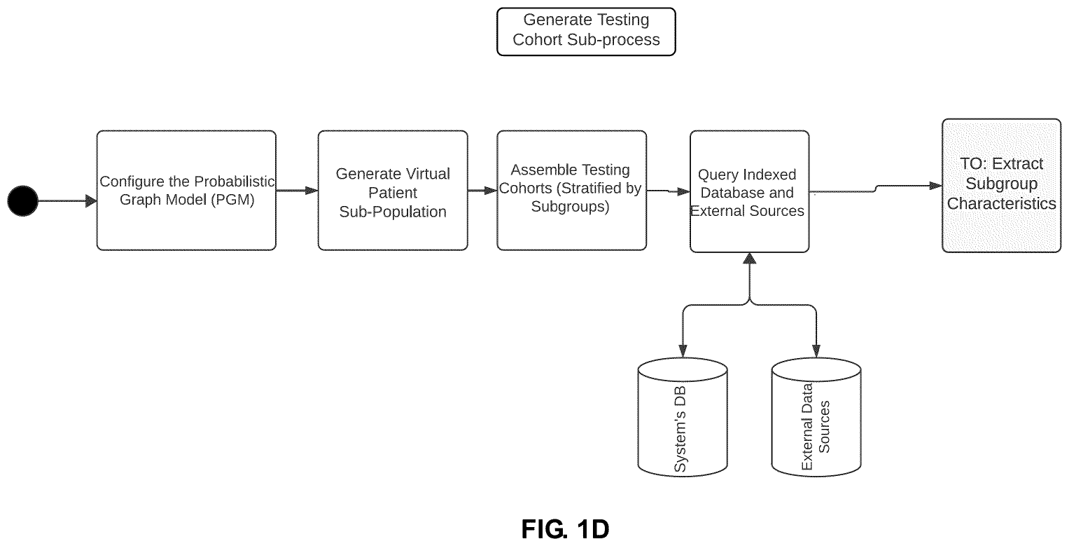

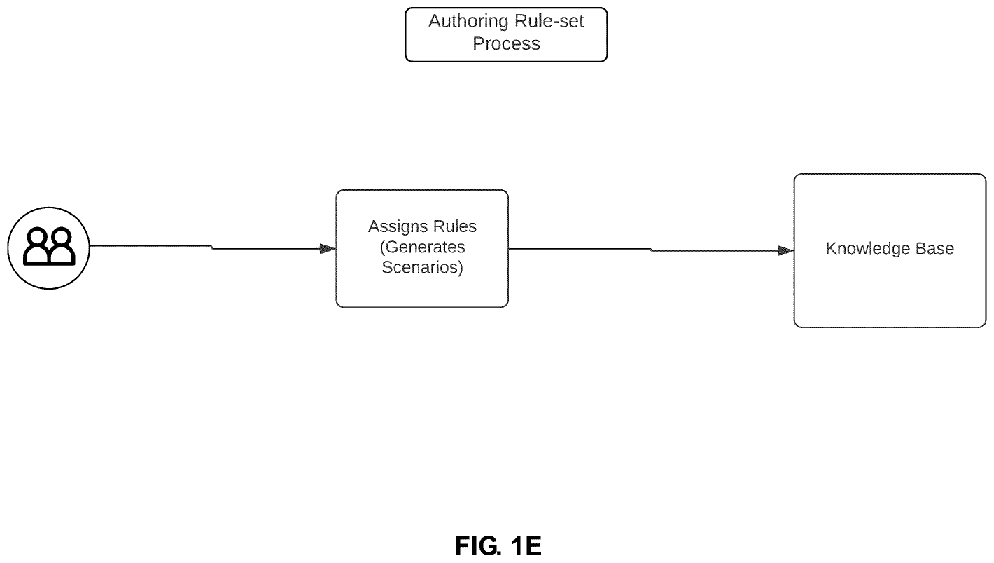

In a representative embodiment, a software-based system hereof includes three software applications/modules which interact as illustrated in FIG. 1A. Whereas the three software components of FIG. 1A can run independently of each other, architecting, and building the components of the overall solution together allows one to define and evaluate application programming interfaces (APIs) connecting the applications. Moreover, the various software components may be distributed over more than one system. In various embodiments hereof, reference datasets having confirmed truth are stored on a memory system and made available for access to evaluate the performance of an artificial intelligence model in characterizing one of the reference datasets, wherein the artificial intelligence model was independently trained using a dataset other than the reference datasets hereof. Access to data of the one or more reference datasets is secured such that the data of the one or more reference datasets cannot be used in training artificial intelligence algorithms. In that regard, securing the data of the reference datasets may include at least one of (i) limiting or preventing access to the data of the one or more reference datasets for use in training artificial intelligence algorithms or (ii) altering/storing the data of the one or more reference datasets in a reversible manner to diminish the viability thereof in training artificial intelligence algorithms (in the case of access thereto). To demonstrate the impact of the perturbed datasets on potential use in a supervised learning ML task, methods of assessing the influence and importance of various training data on estimation quality may be used by training a predictor using the original reference data set and then training the exact predictor with the perturbed/modified data with the reversable watermarks. As known to those skilled in the art, the Data Shapley is a prominent method arising from Game Theory applicable to quantifying the influence and applicability of different training data. The joint probability distributions of the images (corrupted and non) in the training data sets will only differ by the features injected by the perturbation process. The Data Shapley difference by 5-10% will indicate that the changes to the data were sufficient to affect the underlying distribution to make the samples undesirable for training.

As illustrated in FIG. 1A, the primary users of the system are typically affiliated with different organizations, and each may have varied access and permissions within each subsystem and the total solution. In a number of embodiments, the product is architected in a services-aware paradigm to maximize reuse of microservices and to enable containerized deployments of the system.

The Reference Dataset Builder application in the embodiment of FIG. 1A is a primary interaction point for users defining reference datasets, suggesting dataset attributes to be considered, integrating constraints and guidelines from external sources, and as a ‘broker’ to enable the data sourcing and reference dataset fulfilment processes to commence and execute.

In a number of embodiments, functionality may be provided to allow users (for example, manufacturer clinical science/regulatory teams) access to, for example, provide sample size estimations of training and external data set validation.

In a number of representative embodiments, the process for creating a reference dataset includes application of a series of rules that are developed and refined by ruleset authors and editors. These rulesets are used in directing the assembling of reference datasets and test cohorts, which are important, for example, for evaluating an AI model's bias across subgroups, fairness, and its response to data variations or noise like those found in actual clinical settings. The performance data of an AI model amidst data variability may be collected and reported as benchmark scores. Several representative benchmark categories include, for example, detectability, precision, and accuracy.

The Reference Dataset Builder plays an important role in forming testing cohorts and fulfills a number of purposes within the systems and methods hereof. In a number of embodiments, it is utilized by ruleset authors to apply specific rules during the creation of a reference dataset and testing cohorts for a particular AI model evaluation. Moreover, the resulting composition of the reference datasets, derived from the applied rules, may inform the data curation process. Data may, for example, be collected and aggregated from various sources based upon data requirements (for example, to fulfill a need to ensure data are from diverse geographical areas). That process may, for example, be enabled by a decision tree structure that assists ruleset authors and dataset users-both individuals and software modules—in their respective tasks. The decision tree may be multi-tiered, with nodes such as cancer type, data types used by the AI model, the cancer's stage of progression, and the clinical tasks the AI model is designed to support.

The decision tree's pathways conclude at distinct endpoints. At such endpoints, there are rules that assist in, for example, specifying the type of subgroups to test, the metrics to use in assessing AI fairness and robustness, and the categories and levels of data variability. In a number of embodiments, a “scenario” is conceptualized as the collective nodes that emerge from a single path through the decision tree. See, for example, FIGS. 1B through 1E. A representative scenario may be external testing of an AI model for processing CT lung/chest (non-contrast) and making a binary classification of findings in the study based on the BIRADs system arising from a baseline, lung cancer screening exam for patients anywhere in the US. The ‘intended use’ portion of this scenario is the phrase “classification of findings in the study based on the BIRADs system”. When, for example, using the reference datasets to test AI models as part of a study to help obtain market clearance from a regulatory body such as the FDA, this intended use may also be mapped to a product-code published by the US FDA. If a product-code does not exist, the product code category will be ‘deNovo’.

Another endpoint of a decision tree path are rules defining the fairness metrics and data variability categories to use in constructing a dataset. Authoring users of the system will be prompted to select or define the fairness metrics that are most appropriate for the AI model's application, taking into account any additional constraints or considerations relevant to the scenario. Fairness metrics, a term familiar to ethicists and healthcare specialists studying the societal implications of computational algorithms, are quantitative measures that can help to evaluate whether an algorithm's predictions are equitable across various groups, particularly those that may be at a disadvantage. Examples of such metrics include Disparate Impact, Statistical Parity Difference, rates of under or over-diagnosis, Equal Opportunity Difference, Theil Index, and Consistency. Determining the most suitable metrics for a scenario necessitates expert assessment from the fields of medicine and ethics. These metrics are vital for evaluating the AI model's performance across diverse subgroups, defined by age, gender, race, ethnicity, and socio-economic status. The selection process for these metrics is both democratic and systematic, utilizing a Delphi method to achieve consensus among experts. Such an approach ensures that the selected metrics are scientifically robust and reflect the collective expertise of seasoned professionals.

Another endpoint of the decision tree is a rule that defines the type and degree of data source variability. Data source variability categories encompass factors and covariates known or anticipated to adversely affect the functioning of AI/ML models. A logic that identifies the most critical categories of data source variability may, for example, be encoded in the rules. In representative embodiments, the rules take into account the different factors that may influence the model's performance and ensure that the testing process is thorough and reflective of potential real-world conditions. Data variability sources important for difference scenarios and levels are declared and stored in the rulesets. Some sources of variability are due to factors with knowable variations like the different manufacturers of scanners used to acquire imaging data. Other sources of variability are more stochastic and arise from intrinsic (to the patient and pathophysiology) and extrinsic (streaking, image noise) noise processes. It is important to ensure test data in the reference datasets exhibit these variabilities.

It is not feasible to construct external tests datasets representative of all sources of variability. Not every intrinsic and extrinsic noise source are important to consider when assessing a particular AI model's use scenario, however. For example, a surgical screw in a hip repair will likely cause streaking artifact when a CT scan of the pelvis is performed. If the AI model being tested in the system is trained to characterize brain tumors, the presence of the potential streak from a surgical screw will not impact the brain CT imagery. Likewise, breathing artifact will not affect a head CT like it would or does a lung CT scan

The Reference Dataset Manager application in the embodiment of FIG. 1A is predominantly a ‘headless’ application in that it is not intended to be directly accessed by the end user. Rather, it is a collection of services to search, process and curate reference datasets using data assets in available private libraries (for, example, libraries available from the Gradient Health of Raleigh, North Carolina) and other external data sources. Indexing and curation may be extended to on-premises deployments in, for example, data partner facilities. Outputs from the Reference Dataset Manager application include the reference datasets themselves, which are accessed by the Reference Dataset Evaluation and Reporting Application as discussed further below. The Reference Dataset Manager application in the illustrated embodiment has the responsibility of reference dataset persistence and data integration.

A core function of the Reference Dataset Manger is to assemble a test dataset or cohort that reflects as much as possible the characteristics defined in the rulesets. Rulesets are accessed by the Dataset Manager as a function by input from the user of the system. The categories and label-types are defined by the rulesets. Now that the system has an idea of how a testing cohort of a reference dataset should be constructed, the system next assembles testing cohorts using those rules and data curated from external sources and providers.

The Reference Dataset Manger accesses test data that are already indexed by the system in a system database. However, the Reference Dataset Manger will also query external sources of medical testing data, like the US NIH's Medical Imaging & Data Resource Center Data Commons MIDRC data portal. As mentioned above, it's not feasible to source and index all possible permutations of patient and procedure in the testing datasets. A goal in a number of embodiments of the systems hereof is to arrive at the most important and representative testing datasets. To determine the representativeness of the resulting dataset cohort, a representative embodiment of the Reference Dataset Manger uses a population model built as a probabilistic graph model (PGM), informed by source data from the biomedical literature and references like the US Census Bureau and the National Cancer Institute SEER databases. In general PGMs, are a framework that provides a compact representation of joint probability distributions over complex domains (that is, joint (multivariate) distributions over large numbers of random variables that interact with each other). PGMs are a type of Directed Acylic Graph and the preferred configuration for this application is in the form of a Bayesian Network. The model here can be used to generate a joint-probability distribution for situations in which conditional probability relationships among variables are known and when they are unknown. Inferences can be made upon the missing values. By building ‘virtual populations’ with this model, the system can then query the known data sources to start building dataset ‘tranches or strata. The actual data queried and assembled into testing datasets will be determined, therefore, by the rulesets and the expected, statistical variability expected in a sub-population for varying scenarios.

The Reference Dataset Manager utilizes source data to establish the conditional probability distributions of the PGM. An inference method, such as Gibbs sampling, enables the PGM to generate a sample that accurately represents a specific sub-population within a designated region. While factors like the CT scanner's manufacturer, acquisition parameters, and certain noise processes remain independent of patient demographic characteristics, other acquisition parameters may vary depending on these demographics. For instance, the X-Ray tube potential required for a lung CT scan is likely to be higher for patients with a Body Mass Index (BMI) exceeding 30. Employing a PGM provides the versatility to explicitly model such interactions, whether the source probability distribution is known or when both source and conditional probability distributions are unknown and must be inferred.

An important function of the Reference Dataset Manager in a number of embodiments of a system hereof is reporting to the user(s) (via the Reference Dataset Evaluation and Reporting Application) the composition and attributes of appropriate datasets and their subgroups or strata. Testing datasets for the Application are representative of data the AI model would encounter in use. The dataset subgroups are constructed so that the AI model is tested with data cohorts reflecting the variation of patients, medical devices, artifact, noise, and the phenotypic expression possible when it used in clinical settings. For example, an important category of data source variability is scanner manufacturer. A hypothetical ruleset might stipulate to demonstrate representativeness of the AI model's performance, the testing dataset should have image data that follow the probability distribution of scanner manufacturer across the US (in the case that the region where the model will be deployed is the US). In this representative example, the market share of the major CT scanner manufacturers should be encoded in the rule. The data sources may not have imaging data collected in meaningful quantities to support the sample-size suggested by the system, however. The actual data that the Reference Dataset Manager can assemble for a particular cohort may have only 50% of the data for one manufacturer. Subsequent data analysis and reporting must reflect that situation if the user decides to proceed in evaluating the model with the dataset cohort curated for the specific scenario. Likewise, the available data will be used to update calculations of sample size and confidence intervals on performance metrics (like area under the curve (AUC) or partial area under the curve (pAUC)). Those performance metrics are constituent elements of the fairness metrics used in constructing fairness metrics for the testing dataset as dictated by the ruleset. A number of approaches have been and are being developed to test computational algorithms, like AI models, for so-called ‘fairness’. Attention is being placed on developing performance metrics to enable the comparison of subgroups within a larger cohort, especially if a subgroup is representative of a minority or a disadvantaged, socio-economic demographic. One such metric is the xAUC, developed by Kallus and Zhou to assess the disparate impact of risk scores created by Machine Learning models that stratify disease likelihood. We incorporate the xAUC as one performance metric. Other metrics include covariate-adjusted Receiver Operating Curve (ROC) calculations that weight different sub-groups in a sample to help ensure that subgroups with fewer samples are adequately expressed. Methods known to statisticians for developing stratified samples may also be incorporated.

The Reference Dataset Evaluation and Reporting application is the application with which users such as manufacturers, FDA (and/or other regulatory agencies), and end users/clinical purchasers will interface the most. A function of the Reference Dataset Evaluation and Reporting application is to coordinate the standalone testing tasks of the system using available and selected reference databases that the overall system has identified. Manufacturer users may also register and securely upload encrypted AI models into the distributed computing infrastructure underpinning this module. Output including performance results and summary statistics are accessible via web interfaces to this application in addition to visualization of reference dataset imaging assets and AI model outputs. This application also serves as an access point for healthcare system users wanting to evaluate the performance of multiple oncology AI products from different manufacturers when evaluating AI products for purchase.

In a number of embodiments, the composition of the reference datasets is clearly articulated and rationalized, allowing trust in the reference datasets by stakeholders and users. Trust in the datasets may, for example, be engendered by using external, expert guidelines and information to guide their development. The Reference Dataset Builder software module/application allows adequately permissioned users to define, construct and review reference datasets definitions (RDD). A reference dataset definition includes the rules defining its construction and statistical characterization of the data to be populated within it. In a number of embodiments, the output from the Reference Dataset Builder application is both human and machine readable. The human readable output is necessary to allow for peer review and feedback from, for example, FDA review teams and independent experts. Because standalone performance assessment is a useful paradigm to stress test AI algorithms, and because different oncology AI products will have different functionality (for example, binary detection of a lesion vs. categorizing subtype), one or more subgroups of reference datasets may be defined. Each of such subgroups (which is itself a reference dataset) is sometimes referred to herein as a Reference Dataset Tranche (RDT). Three representative tranche types include a Cancer Subtype Tranche, an Imaging Acquisition Tranche, and an Imaging Robustness Tranche.

A “Cancer Subtype Tranche” may, for example, be used to assess AI algorithm performance as a function of cancer subtype (histopathologic, genetic, and radiographic). For AI products attempting to distinguish subtypes, a reference dataset composed of prevalence proportionate data is a necessity. Data within such a tranche may be sourced and collected to ensure a statistical distribution representative of the prevalence in the US population using, for example, National Cancer Institute (NCI) resources such as The Surveillance, Epidemiology. and End Results (SEER) Program. SEER provides information on cancer statistics designed to reduce the cancer burden among the U.S. population.

An “Imaging Acquisition Tranche” may, for example, provide a reference dataset with imaging data representative of imaging modality type (e.g.: CT, PET/CT, MRI), manufacturer market share, and having image acquisition variability representative of clinical reality. Professional society resources such as, for example, the American College of Radiology (ACR) Data Sciences Institute's AI Use Cases, the Radiological Society of America's (RSNA's) Quantitative Imaging Biomarkers Alliance (QIBA) standards, and The American Association of Physicists in Medicine (AAPM) protocol guidelines may be used to define the acquisition varieties.

An “Imaging Robustness Tranche” may, for example, be used to assess the robustness of an oncology AI algorithm in the presence of, for example, anatomical variants, patient movement/artifact and other noise encountered in real world deployments of imaging, oncology AI products. Sources guiding the Imaging Acquisition Tranche will also inform the design of this subset.

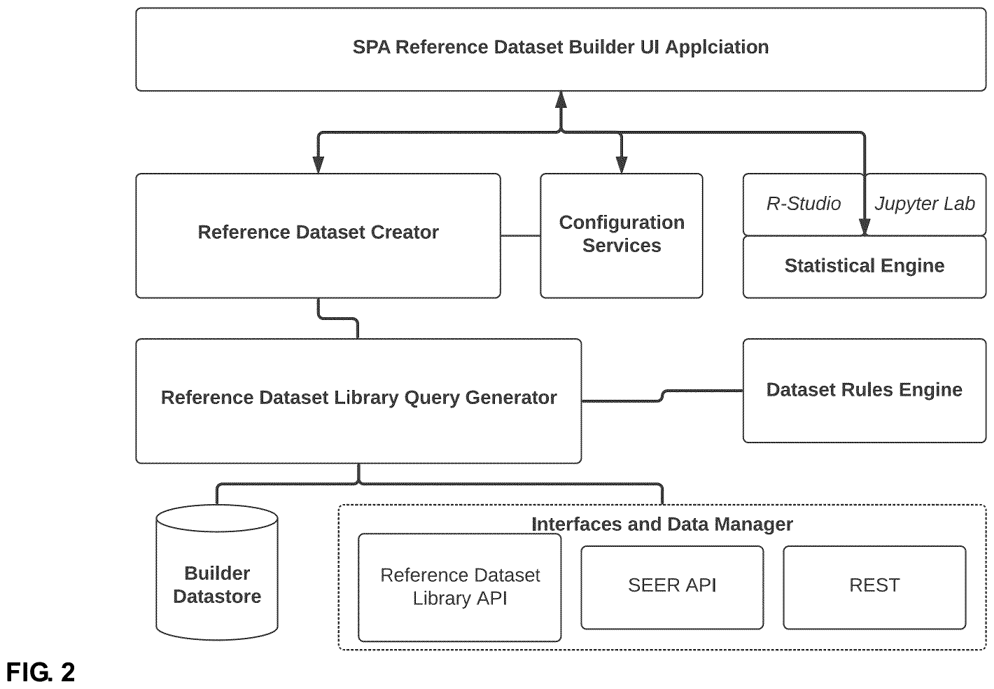

A representative embodiment of a software architecture for the Reference Dataset Builder User Interface application is illustrated in FIG. 2 In a number of embodiments, use of a Single Page Application (SPA) facilitates user interaction and generate work tasks. A single-page application is a web application or website that interacts with the user by dynamically rewriting the current web page with new data from a web server, rather than loading entire new pages, which is the default method of a web browser. Faster transitions result and provide a feel more similar to a native application.

In a number of embodiments, the reference datasets are maintained evergreen. In that regard, representative data is incorporated as it becomes available through data networks. The Reference Dataset Builder application may, for example, thus allow registered users access for those purposes. In a number of embodiments, a “Reference Dataset Library Query Generator” coordinates the construction of the tranches, prompts for user input, and promotes or triggers ingestion of data. Based upon reference datasets definitions, the software component may, for example, query the SEER database and return prevalence stratification for each subtype along with the statistical distributions of US population demographic, racial, gender and age for each subtype.

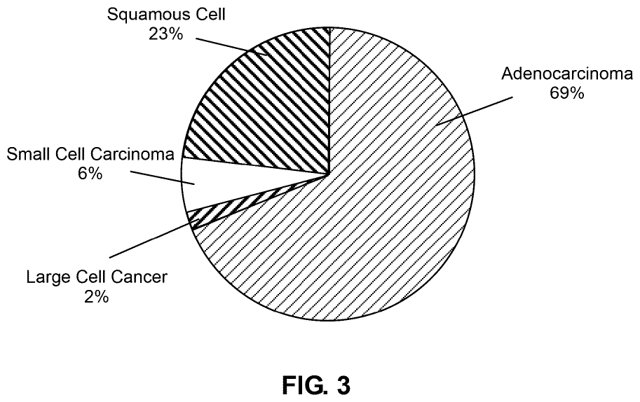

As a representative example of the functionality, the SEER 12 data was accessed via the SEER API for Lung and Bronchus cancer prevalence data. Representative subtype proportions (prevalence of lung cancer subtypes in the US) are plotted in FIG. 3, with the following prevalence of lung cancer subtype in the US indicated: adenocarcinoma 69%, squamous cell 23%, small cell carcinoma 6%, and large cell cancer 2%. To help generate Receiver Operating Curves (ROC) with less ‘blockiness’, the minimum sample size of a tranche subtype may be seat at, for example, 50 cases (25 positive and 25 negative). The minimum sample size of a subtype classification tranche is the lower limit sample size (50) divided by the corresponding prevalence percentage (in this example, 2%). Thus, the minimum number of positive cases in the Cancer Subtype Tranche for this cancer is 1,250 positive cases (for fully balanced datasets, one also needs 1250 negative cases). Users may, for example, be allowed to perform statistical computations using their own code to evaluate sample size methods and considerations to bring added flexibility into the tool.

In a number of embodiments, hereof, the reference datasets hereof have specific source data requirements that use searching and indexing functionality with robust informatics capabilities to account for the imaging specific terminologies describing image acquisitions, variation in clinical and radiologic terminology used by radiologists and oncologists, and variable units and terms encoding laboratory and molecular pathology findings. Data modelling, natural language processing (NLP), and search capabilities enable efficient search of existing records and public data sets, as well as identifying source data in clinical partners' information repositories. The clinical reference truthing for oncology cases is largely derived from histopathology, surgical, and molecular pathology confirmation. Robust pipelines for the ongoing mining of data may, for example, provide functionality for parsing/cataloging such data sources. It is also anticipated that independent review of some datasets by new experts will be necessary to satisfy certain types of testing. Annotation and labeling capabilities can be interfaced into the system to enable that functionality.

Reference datasets defined, curated, and managed herein may be curated from, for example, millions of studies in the Gradient Health and/or other libraries. The enhanced NLP and indexing tooling hereof may be used in matching the reference standard ‘truth’ data to imaging studies, thereby reducing the amount of manual truthing/annotation.

Tagging clinical findings for future cohort creation and storing clinical data for large scale exports is challenging to, for example, hospitals which primarily focus on clinical service, which leads significant wait time on creating a cohort for research export. Gradient Health has, for example, developed a cost-effective solution which tags clinical findings, reversibly redacts protected health information (PHI), and stores data in cloud archives for AI development scale. Once integrated with a hospital or service line, data are searchable for cohort creation which is desirable for curating oncology data for reference dataset creation because of the desire to extract truth from the medical record. Traditionally, removal of PHI is manually time consuming and is prone to errors with PHI false positives leading to data loss, and PHI false negatives leading to data leaks.

As described above, the “Reference Dataset Manager” application coordinates the fulfilment of data from libraries into reference dataset tranches. In a number of embodiments, upon the creation of a new reference dataset tranche, a preprocessing pipeline creates smart queries using common data elements and coded concepts related to the exam, subtype phenotype, patient demographics, comorbidities, and image quality requirements. Such structured elements expedite the traversing of the library data. Structured queries to repositories like the NCI Data Commons or Medical Imaging and Data Resource Center (MIDRC) may also be made to identify any potential matches within those public resources. The system hereof may, for example, attempt to fill a tranche with as much data as available which satisfies the reference data definitions. When a minimum number of datasets are found within the library, those data are tagged for inclusion. The source data may, for example, be marshalled and readied for review and approval by the dataset author or an authorized representative. The system may enable review of the image data sets using, for example, the Open Health Imaging Foundation (OHIF) viewer (a zero-footprint medical image viewer) component. Computational enhancements to data analysis, retrieval and indexing capabilities may be used to find data satisfying more quickly and accurately the reference data definitions. Upon review and approval, the reference dataset tranche may be marshalled to its datastore. Continual sourcing, curating and selection of data into the reference datasets may occur as new data assets become available or a new request is made by a user.

Enhanced searches, NLP and analytical methods to parse and extract oncology specific features (textual or image) may be used in satisfying the requirements of reference dataset creation. Known methods to create search and language task performance as demonstrated in the broader AI community may be adapted for use herein. Oncology-focused querying and dataset parsing required herein may be iterated using available data modeling and persistence capabilities.

As set forth above, if a reference data set were made freely available, the data and labels could be incorporated into oncology AI training cohorts, which would eliminate the value of the reference dataset's independent and external nature. Furthermore, manufacturers do not want external parties to have access to the internals of their in-development algorithms. Thus, the systems hereof provides the ability to execute a trained AI model without the reference data set leaving internal control of the system while keeping a manufacturer's AI model secure.

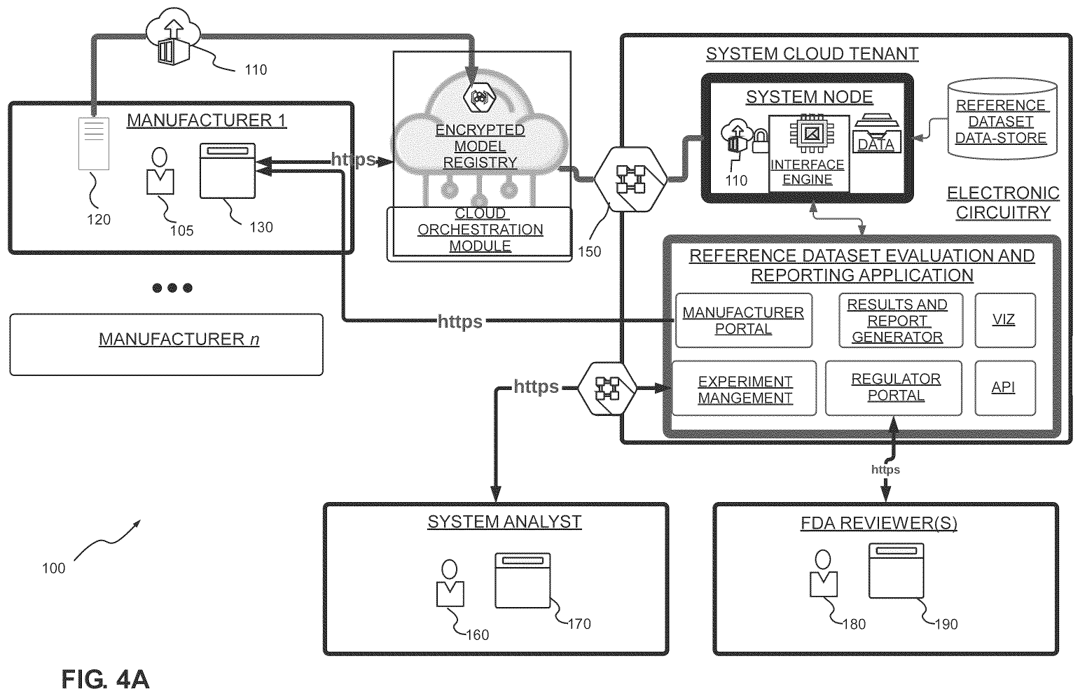

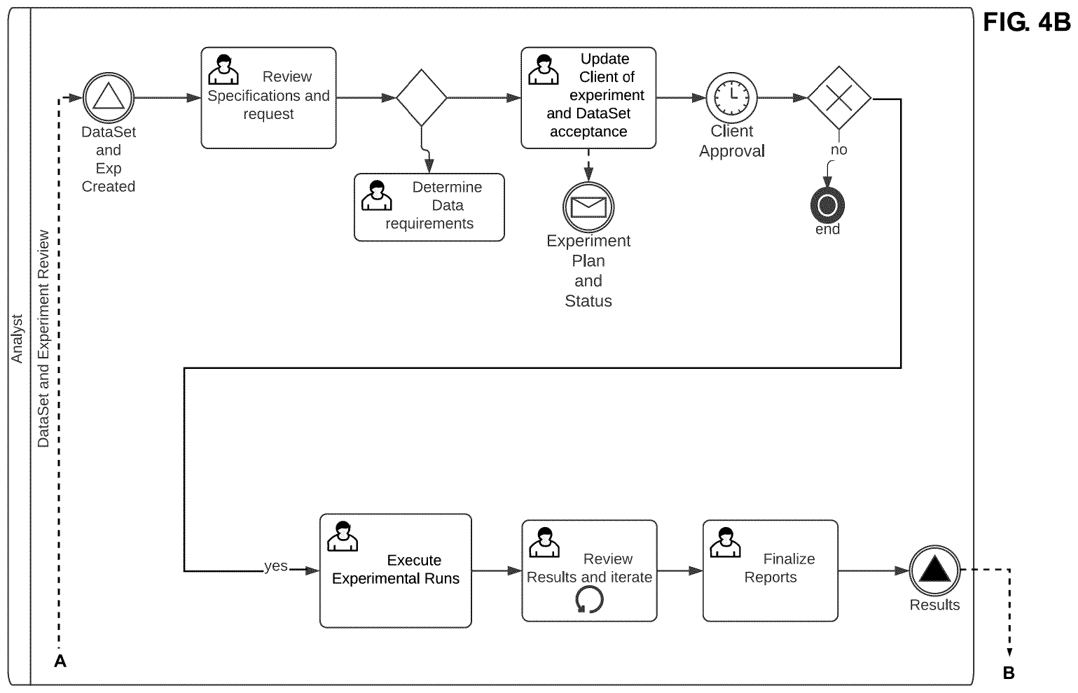

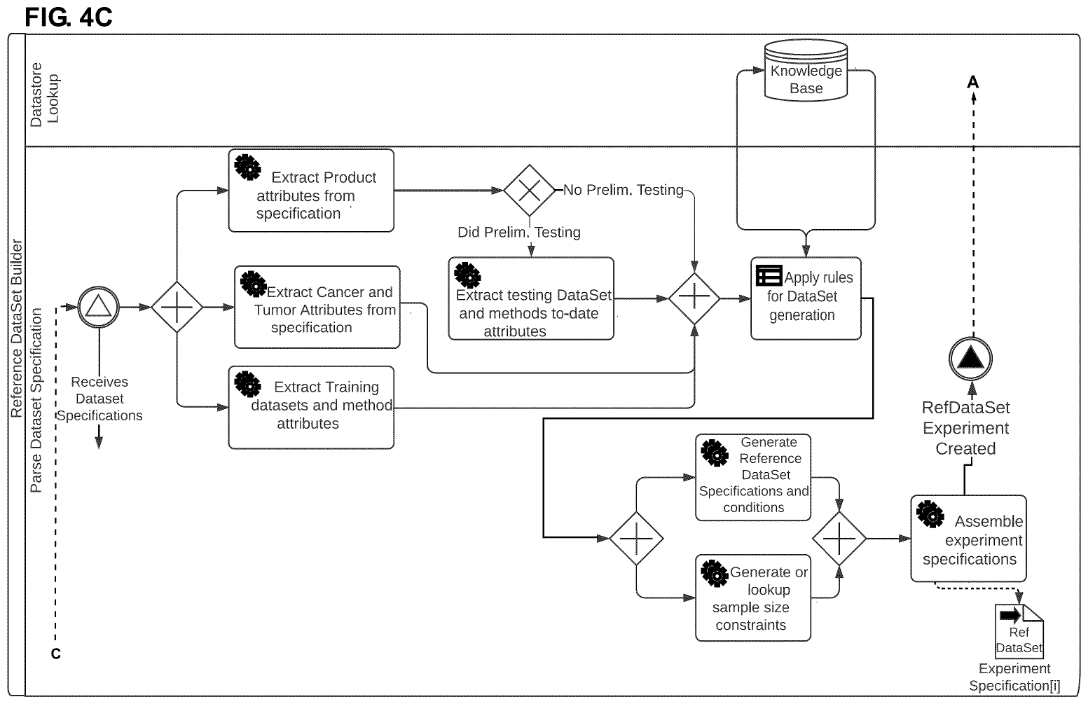

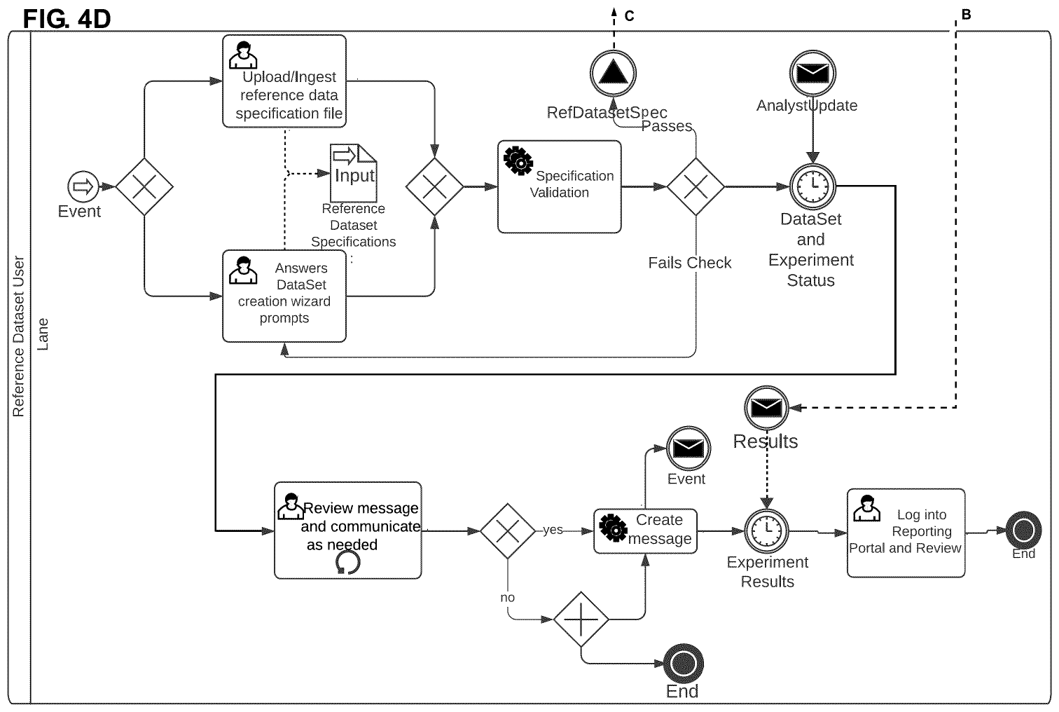

In that regard, in a number of embodiments, and referring to FIG. 4A, the Reference Dataset Evaluation and Reporting Application/Module allows a tester 105 at a manufacturer to securely register an AI model 110 (from a quality assurance server (QA) or a regulatory affairs (RA) server 120) via a web browser 130 via a virtual private cloud 150 in communicative connection with an encrypted model registry for testing against one or more reference dataset tranches available in the system reference dataset data-store. A containerized AI model 110 may, for example, be encrypted as it is ingested into an encrypted model registry of the software platform. In a number of embodiments, a software platform designed for federated learning and distributed computation is used in connection with a trained AI model. For example, the Rhino Health Platform (RHP; available from Rhino Health of Boston Massachusetts) is an off-the-shelf software technology proven in numerous global AI consortia and was designed to allow for federated learning and distributed computation upon data sets that stay resident within a defined enclave. Federated learning (which is also referred to as collaborative learning) is machine learning methodology that trains an algorithm across multiple, decentralized edge devices or servers having local data samples without exchanging such data samples. A principal tenant of the RHP is that computation happens on local data assets while secure access is allowed to the testing results and summary statistics. As alternatives to use of the RHP in systems hereof, there are open-source federated learning tools and other available privacy enhanced computing tools that may be used in the system hereof.

Referring for example, FIG. 4A, a federate learning or similar platform such as the RHP distributed deployment model may be leveraged to fulfill requirements to keep both reference datasets and AI models 110 secure. Edge computing occurs at local nodes while a centralized cloud orchestration module coordinates and manages activities across the network. Edge computing is a distributed information technology architecture wherein client data is processed at the periphery of the network, close to an originating source. In a number of embodiments hereof, AI models 110 are ingested into, for example, the Rhino Health Platform model registry and are available for execution at any of the nodes. AI model manufacturers are granted permissions to register their encrypted model 110 into the model registry. A local Rhino Health Platform node may, for example, be instantiated in a cloud instance of a system/computer system or electronic circuitry hereof (see FIG. 4A) that hosts a Rhino Client/node, as well as the Reference Dataset Evaluation and Reporting Application and the reference dataset(s) hereof. FIG. 4A illustrates a representative embodiment of a layout of the solution and dataflows among the elements.

In the embodiment of FIG. 4A, an API such as the RHP API is asserted by the Experiment Management services to execute batch experiments using the reference dataset data on a particular AI model 110 via, for example, a system authorized analyst 160 via, for example, a web browser 170. The RHP includes the functionality to generate AI model performance metric artifacts (e.g.: confusion matrices, receiver operating characteristic curves (ROC) when applicable, etc. as is known in the AI arts). The API of the RHP may be used in the Reference Dataset Evaluation and Reporting Application/Module to compile the results and performance metrics into a format appropriate for the tasking. In a number of embodiments, based upon permissions for access and usage, the Reference Dataset Evaluation and Reporting Application/module may communicate performance results in digital form for analysis by the manufacturer and to the FDA. An FDA reviewer 180 may be granted access via a regulator portal using a web browser 190. Web browsers may, for example, communicate in system 100 using http protocol. Flowcharts illustrating embodiments of processes for various users accessing various components of system 100 of FIGS. 1A, 2 and 4A are illustrated in FIGS. 4B through 4D.

Manufacturers and/or other permissioned users may be prohibited from directly accessing the reference source data for download but may be granted limited access to case-level results via the visualization (VIZ) components of the application illustrated in FIG. 4A. Summary statistics and sub-group analyses may be granted to the manufacturer. A registered FDA user may, for example, be able to fully review all executed tests, including review of image-level results and summaries via the Zero Footprint, medical viewing capabilities of the system. A zero-footprint viewer is a cloud-based medical image viewer that provide access to patient medical images and patient information across multiple platforms via a web browser without image data being resident (locally) on a user's desktop.

Further manners in which access to data of the one or more reference datasets is secured such that the data of the one or more reference datasets cannot be used in training artificial intelligence algorithms is described below. As described above, securing the data of the reference datasets may include limiting access to the one or more reference datasets and/or the data of the one or more reference datasets can be stored in a manner such that the use thereof in training artificial intelligence algorithms is significantly diminished or eliminated.

Whereas reference datasets can be isolated from users of these data wishing to train and test AI models using, for example, a federated enclave system as described above and in connection with FIG. 4A, it is conceivable that the datasets may be inadvertently leaked. There are also situations that might arise where direct access to the imaging dataset will be advantageous or preferred, particularly when an AI model's performance is degraded on certain data examples. System 100 of FIG. 4A may, for example, enable users to remotely view the data and methodologies by which the datasets will not be persistent on a client's system (using, for example, well-known methods of streaming data as practiced in many, Zero Foot-Print (ZFP) medical imaging viewers such as the eUnity Viewer available from Mach 7′ of South Burlington, Vermont).

However, it is anticipated that there may be a need for the secure and authenticated sharing of the reference datasets to certain users. In a number of embodiments, methods may be used to securely ‘watermark’ the reference dataset. Cryptographic methods commonly used to, for example, secure ledger technologies such as Blockchain may be used to both secure the provenance of the reference data. Such methods may also enable the unlocking of datasets for user with appropriate credentials.

The practice of digitally watermarking image or video data is well known and practiced by developers or owners of digital image or video assets wishing to ensure a chain of custody for the image data and to prevent users from digitally copying the data and using them in an unlicensed manner. See, for example, Wadheraa, S, et al, Comprehensive Review on Digital Image Watermarking, available from Cornell University (DOI: https://doi.org/10.48550/arXiv.2207.06909) (2022) for a summary of techniques and methods known to those skilled in the art of image processing and analysis. In a number of embodiments hereof, watermarking is used that embeds a pattern only known to the originator of the reference datasets into the image data by modifying/perturbing the Least Significant Bit of pixels within a certain region of non-interest (a so-called RONI) in the medical image (for example in an area removed from the patient that is air). In a number of representative embodiments, a pseudo-random code may be generated and depending on the number of pixels within the RONI, an integer that is the quotient of pseudo random code and the number of pixels may be added to the LSB of the pixel data and then encoded into the DICOM format. The pseudo-random code may be cataloged and entered into a secure ledger along with a Unique Identifier (UUID) for that specific image. If the reference image were released into the public domain, a validation step could be performed by searching for the watermark in the known position and then reversing the watermark by applying the reversing key.

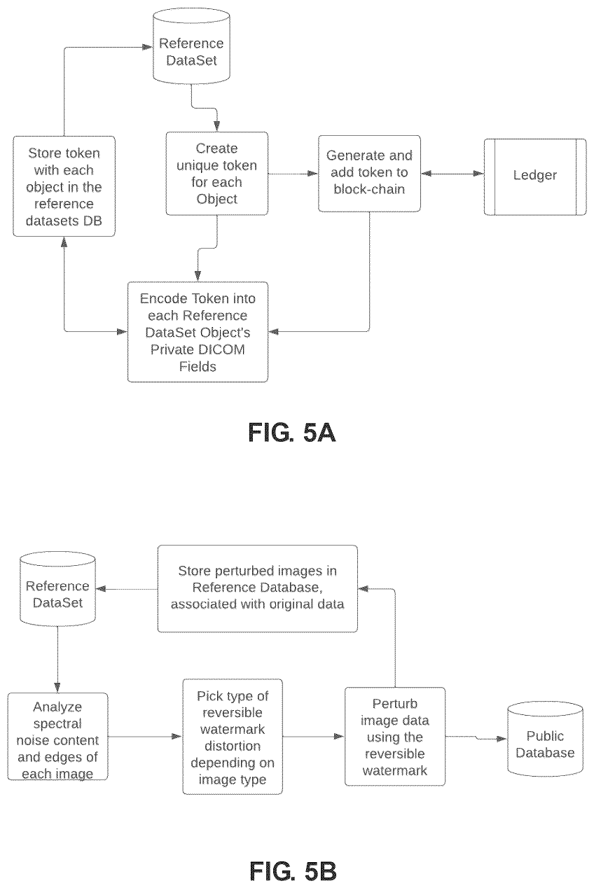

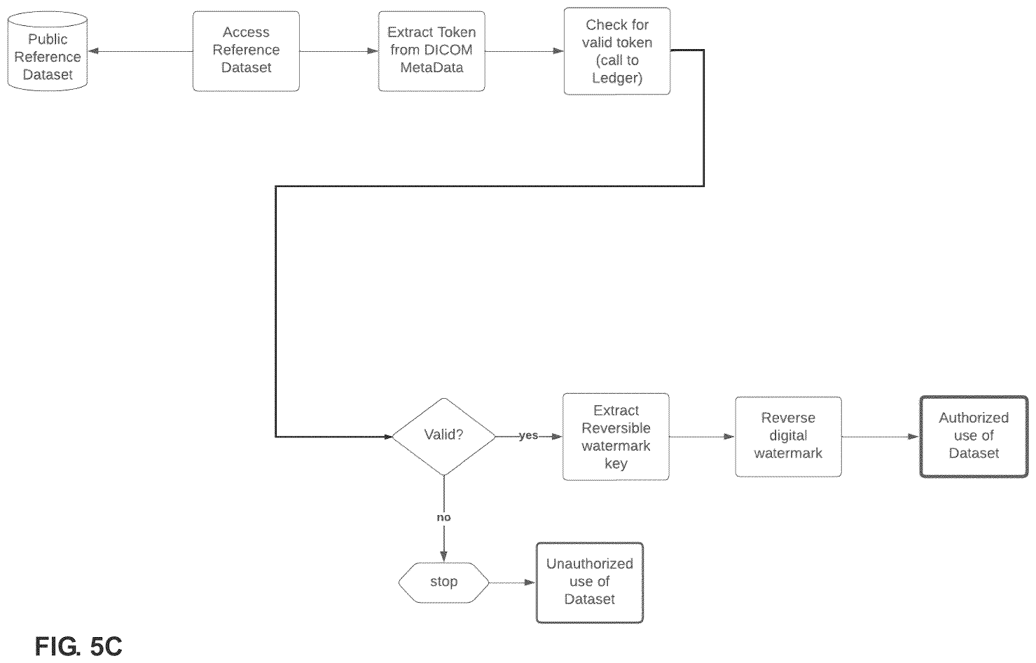

FIGS. 5A and 5B illustrate flow-charts corresponding to an embodiment of such a process. In most digital watermarking applications, the user may not want to visibly perturb the image data. One may thus apply watermarks as described in the previous paragraph that are imperceptible to visual detection. Watermarks can, for example, be used that “burn into” the image/pixel space words or codes and thus will be visible. Those watermarks, however, could readily be compromised by use of standard image analysis techniques. In the representative application of medical image data for training and testing AI algorithms, one may want to use a reversible watermark process that changes the spatial or spectral composition of the image such that, if used in training a ML algorithm, the features would cause the image or study to be meaningfully ‘out of distribution’ of the other training data. Such a “dirty” data sample would thus cause sub-optimal training of the algorithm. Features that might be warped or changed in the image could include: edges of anatomical structures, texture adaptation so that the image data are blurred, or modification to the power spectral density of noise/variation across the image such that it appears unnatural to both human eyes and ML algorithms like Convolution Neural Networks of Vision Transformers. The reversible methods as taught by Sharma, G., and Kumar. V., Preserving IPR Using Reversible Digital Watermarking. in: Sharma. H . . . et al. (eds) Advances in Computing and Intelligent Systems. Algorithms for Intelligent Systems. Springer, Singapore. https://doi.org/10.1007/978-981-15-0222-4_38 (2020) can be applied to a reference data set to remove the perturbations applied during the authorizing stage.

FIG. 5C illustrates a flow-chart representation of an embodiment of such a methodology. Authorization to reverse the watermark may be accommodated by using a UUID and token generated by a non-fungible token process such as that enabled by scalable blockchain networks as offered by Amazon Web Services and the Amazon Managed Blockchain (Distributed Ledger Software & Technology-Amazon Managed Blockchain-AWS). The trusted contract between the owner of the reference dataset and the ledger will result in a token that can be added into the meta-data of the DICOM meta-data within each image object in an imaging reference dataset using a so-called “private DICOM field”. The 64, 128 or 256 bit value can, for example, be directly encoded into the DICOM as a string or numeric data type. Methods as taught by Aguiar, E. J., et al., A blockchain-based protocol for tracking user access to shared medical imaging, Future Generation Computer Systems, Volume 134, p 348-360, ISSN 0167-739X, https://doi.org/10.1016/j.future.2022.04.017 (2022,) may, for example, be applied in the authoring stage of creating the reference data. Likewise, validation of the datasets provenance can, for example, be established by referencing the secured ledger and using the token encoded in the DICOM meta-data. If the token matches that on the blockchain, then the data management system, would issue the key to enable the reversing of the watermark on the image. If the tokens don't match, then a requester will be unable to reverse the watermark and thus will have a corrupted image and will be incentivized not to use the unlocked imagery in an ML training activity.

A system hereof may, for example, be an element of the FDA's Medical Device Development Tools (MDDT), which is a program designed to facilitate device development and timely evaluation of medical devices, and promote innovation. In that regard, the MDDT is designed to provide a more efficient and predictable means for collecting the necessary information to support regulatory submissions and associated decision-making.

Prior to the present devices, systems and method, no trusted and known data sets existed to which manufacturers, regulators, or end users could refer when evaluating the performance of oncology ML algorithms. Whereas researchers and developers have access to public data sets when building and testing ML models, each manufacturer must expend effort to review and scour those resources for data applicable for their application and determine if the truthing for the data seem robust. The privacy enhanced computation technologies incorporated into the devices, methods, and systems hereof (for example, via the Rhino Health platform) prevent applicants from accessing the internals of the AI algorithm while also ensuring the reference data sets stay within the secured enclave of the testing environment. A manufacturer can choose to use the testing process and results to substantiate parts of or potentially the entirety of its stand-alone performance assessment activities per the special controls of radiologic, ML/AI products.

Once again, it is undesirable for the curated data comprising reference datasets to be directly downloadable (particularly, the DICOM imaging data) to ensure the integrity of the reference dataset concept. Digital Imaging and Communication in Medicine or DICOM is the international standard to transmit, store, retrieve, print, process, and display medical imaging data. As described above, manufacturers (as well as regulators) may, for example, be able to review and work with the source imaging data and processed results using the zero footprint visualization components of the system. Thus, no image data will be resident (locally) on a user's desktop.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

What is claimed is:

1. A method, comprising:
providing a computer system, the computer system comprising a processor system and a memory system in operative connection with the processor system, the memory system having one or more reference datasets which have confirmed truth stored thereon, wherein access to data of the one or more reference datasets is secured such that, at least one of: (i) the data of the one or more reference datasets cannot be accessed for use in training artificial intelligence algorithms or (ii) the data of the one or more reference datasets is altered to diminish the viability thereof in training artificial intelligence algorithms, and
providing a portal system to access the computer system over a network via a computing device so that a user can access one of the one or more reference datasets to evaluate the performance of an artificial intelligence model in characterizing the one of the one or more reference datasets, wherein the artificial intelligence model was independently trained using a dataset other than the one or more reference datasets.

2. The method of claim 1 wherein the memory system further has stored thereon an evaluation algorithm which is executable by the processor system to evaluate performance of artificial intelligence models in characterizing the one of the one or more reference datasets, and wherein the method further comprises:
executing the evaluation algorithm to evaluate the performance of the artificial intelligence model in characterizing the one of the one or more reference datasets; and
providing output of evaluation information characterizing the performance of the artificial intelligence model generated by the evaluation algorithm via the portal system to the computing device.

3. The method of claim 1 wherein the artificial intelligence model is stored in the memory system of the computer system and is executable by the processor system.

4. The method of claim 3 wherein the artificial intelligence model is transmitted to the computer system via the portal system in an encrypted, containerized format from a manufacturer thereof and stored on the memory system.

5. The method of claim 4 wherein a federated learning platform is used to transmit the artificial intelligence model to the computer system.

6. The method of claim 1 wherein the user is provided access to the one or more reference datasets to execute a plurality of artificial intelligence models to characterize the one of the one or more reference datasets to evaluate the performance of each of the plurality of artificial intelligence models in characterizing the one of the one or more reference datasets, wherein each of the artificial intelligence models was independently trained using a dataset other than the accessed one of the one or more reference datasets.

7. The method of claim 6 wherein one of the plurality of artificial intelligence models is a predicate artificial intelligence model.

8. The method of claim 1 wherein access to the portal system is provided via a web browser.

9. The method of claim 1 wherein each of the one or more reference datasets is created based upon predetermined rules defining construction and statistical characterization of the data to be populated therein.

10. The method of claim 9 further comprising making information available to at least the user describing the process of creation of the one or more reference datasets.

11. The method of claim 1 wherein each of the one or more reference datasets is an image dataset wherein an oncologic condition associated with each image dataset thereof is confirmed by at least one of pathologic confirmation or radiographic confirmation.

12. The method of claim 11 wherein the one or more reference datasets are divided into tranche types comprising a cancer subtype reference dataset tranche, an imaging acquisition reference dataset tranche, and an imaging robustness reference dataset tranche.

13. The method of claim 9 wherein the predetermined rules are used in creating the reference datasets to enable evaluation the artificial intelligence model in determining at least one of (i) bias across subgroups, (ii) fairness, and (ii) response to data variation.

14. A system, comprising:
a processor system and a memory system in operative connection with the processor system, the memory system having one or more reference datasets which have confirmed truth stored thereon, wherein access to data of the one or more reference datasets is secured such that, at least one of: (i) the data of the one or more reference datasets cannot be accessed for use in training artificial intelligence algorithms or (ii) the data of the one or more reference datasets is altered to diminish the viability thereof in training artificial intelligence algorithms, and
a portal system to access the computer system over a network via a computing device so that a user can access one of the one of the one or more reference datasets to evaluate the performance of an artificial intelligence model in characterizing the one of the one or more reference datasets, wherein the artificial intelligence model was independently trained using a dataset other than the one or more reference datasets.

15. The system of claim 14 wherein the memory system further has stored thereon an evaluation algorithm which is executable by the processor system to evaluate performance of artificial intelligence models in characterizing the one of the one or more reference datasets and to provide output of evaluation information characterizing the performance of the artificial intelligence model via the portal system to the computing device.

16. The system of claim 14 wherein the artificial intelligence model is stored in the memory system of the computer system and is executable by the processor system.

17. The system of claim 16 wherein the portal system is further configured to enable transmission of the artificial intelligence model to the computer system in an encrypted, containerized format from a manufacturer thereof for storage on the memory system.

18. The system of claim 17 wherein a federated learning platform is used to transmit the artificial intelligence model to the computer system.

19. The system of claim 14 wherein each of the one or more reference datasets is created based upon predetermined rules defining construction and statistical characterization of the data to be populated therein.

20. The system of claim 19 wherein the predetermined rules are used in creating the reference datasets to enable evaluation the artificial intelligence model in determining at least one of (i) bias across subgroups, (ii) fairness, and (ii) response to data variation.
